(19) United States
(12) Patent Application Publication
(10) Pub. No.: US 2010/0178383 A1
(43) Pub. Date: Jul. 15, 2010

(54) Sparkling sake and method for producing the same

(76) Inventors: Noriyoshi Nagai, Gunma (JP); Kenji Goto, Gunma (JP)

Correspondence Address: Franklin E Gibbs;Wang Hartman Gibbs & Cauley, 1301 Dove Street, Suite 1050, Newport Beach, CA, 92660, US

(21) Appl. No.: 12/310,853

(22) PCT Filed: Oct. 8, 2008
(86) PCT No.: PCT/JP2008/069278

§ 371 Date: Mar. 9, 2009

(30) Foreign Application Priority Data
Oct. 10, 2007 (JP) 2007 264067

(51) Int. Cl. C12G 3/02; C12G 3/04; C12G 1/08

(52) U.S. Cl. 426/13; 426/11; 426/592

(57) ABSTRACT

An object of the present invention is to provide an in-vessel fermentation type sparkling sake obtained by allowing mixed sake, which is prepared by mixing sake obtained by squeezing with turbid sake obtained by roughly filtering sake mash containing yeast and having fermentation activity, to generate carbon dioxide gas in a hermetically sealed vessel, wherein the sparkling sake generates fine bubbles like those from champagne, is palatable, is less turbid, and has a refreshing flavor, and to provide a method for producing the same.

Disclosed is sparkling sake characterized in that the sparkling sake is prepared by using rice and rice koji as raw materials; carbon dioxide gas present in the vessel is the carbon dioxide gas substantially generated by secondary fermentation; and the content of the carbon dioxide gas is 3.0 GV or more.

### TECHNICAL FIELD

The present invention relates to sparkling sake, particularly in-vessel fermentation type sparkling sake obtained by allowing mixed sake, which is prepared by mixing sake obtained by squeezing with turbid sake obtained by roughly filtering sake mash containing yeast and having fermentation activity, to generate carbon dioxide gas by secondary fermentation in a hermetically sealed vessel, and to a method for producing the same.

### RELATED ART

Many types of sake are present according to consumers' needs, and sparkling sake containing carbon dioxide gas is one of them. Conventional sake containing carbon dioxide gas can be roughly divided into the following three types according to how carbon dioxide gas is contained therein: first type: sparkling sake obtained by blowing carbon dioxide gas into sake; second type: natural fermentation type sparkling sake in which carbon dioxide gas is obtained by post-fermenting sake in a hermetically sealed sake mash pressure tank having a large volume; and third type: in-vessel fermentation type sparkling sake in which carbon dioxide gas is obtained by post-fermentation (secondary fermentation) of sake in a vessel for sale.

Here, the sparkling sake obtained by blowing carbon dioxide gas according to the first type is based on the most general method in the beverage industry in which carbon dioxide gas can be blown by using a carbonator or the like. However, although the sake containing carbon dioxide can be produced by such a method of blowing carbon dioxide gas into sake, this method has the following problems: when this sake is compared with a beverage containing fermented carbon dioxide gas such as champagne, it is unpalatable and tastes rough, because the texture of bubbles is sensed coarse; and in addition when the sake containing carbon dioxide is allowed to stand in the air, its taste and feeling through throat will become bad if the sake containing carbon dioxide poured out in a glass is not drunk up within a short time since carbon dioxide gas is easily escaped therefrom.

The natural fermentation type sparkling sake according to the second type is obtained by post-fermenting sake in a hermetically sealed sake mash pressure tank having a large volume to generate carbon dioxide gas. For example, there is mentioned sparkling sake produced by a method of fermenting sake in a hermetically sealed tank followed by filtration and sealing the resulting clean filtrate in a product vessel, as disclosed in Patent Document 1. However, carbon dioxide gas fermented within a tank according to the production method of Patent Document 1 is fine and palatable, but it is necessary to once take out sake from the tank and filter it. As a result, there is a problem that carbon dioxide gas is discharged through these processes. In addition, there was a possibility of having an adverse effect on the flavor of sparkling sake in these processes in which the sake, which was subjected to secondary fermentation so as to enjoy a fine change of taste, was brought into contact with the outside air.

Further, the in-vessel fermentation type sparkling sake according to the third type is produced by roughly filtering sake mash, putting turbid sake containing yeast and the like into a vessel, subjecting it to secondary fermentation, and stopping the fermentation at the time when the pressure in the vessel exerted by the carbon dioxide gas generated in the secondary fermentation reaches a predetermined value, followed by sterilization by heating, for example, as disclosed in Patent Documents 2 and 3. However, the sparkling sake according to Patent Documents 2 and 3 is so-called unrefined sake, and it differs from the clear image of common sake.

The in-vessel fermentation type sparkling sake according to the third type also includes sparkling sake produced by a method as disclosed in Patent Document 4. This method comprises roughly filtering sake mash to obtain yeast-suspending sake, removing the supernatant portion of the yeast-suspending sake to obtain turbid sake having a high yeast concentration, adding an unsterilized alcohol and water to the turbid sake having a high yeast concentration which is the lees portion, and filling the resulting mixture into a vessel for sale to subject it to secondary fermentation, followed by sterilization by heating at the time when the pressure in the vessel reaches a predetermined value. However, the sparkling sake of Patent Document 4 cannot be called clear sparkling sake because it certainly contains a certain amount of lees although the amount is less than that in the sparkling sake of Patent Documents 2 and 3.

As disclosed in Patent Document 5, the in-vessel fermentation type sparkling sake according to the third type also includes sparkling sake produced by a method of saccharifying and fermenting steamed rice and rice koji in the presence of polyacid, filtering part of rice mash in a low alcohol concentration with a large-mesh filtering medium to separate a turbid liquid which contains yeast and has fermentation activity, pressing the other part of the rice mash to separate a clear liquid, mixing the turbid liquid with the clear liquid, sealing the resulting mixture in a vessel, and stopping the fermentation at the time when the pressure in the vessel reaches a predetermined value by the fermentation in the vessel. However, the sparkling sake of Patent Document 5 has higher transparency than the turbid sake described in Patent Documents 2 and 3, but a small amount of lees still remains in the vessel. Therefore, there are problems that this sparkling sake is not clear enough but is a little turbid, and that since yeast required for fermentation is killed if the alcohol concentration is increased, the sparkling sake is limited to sake having a low alcohol concentration to thereby provide sparkling sake whose flavor is greatly different from the original flavor of sake.

Patent Document 1: Japanese Patent Laid-Open No. 2000-189148

Patent Document 2: Japanese Patent Laid-Open No. 61-47179

Patent Document 3: Japanese Patent Publication No. 07-79674

Patent Document 4: Japanese Patent Laid-Open No. 09-140371

Patent Document 5: Japanese Patent Laid-Open No. 10-295356

### DISCLOSURE OF THE INVENTION

An object of the present invention is to provide sparkling sake which generates fine bubbles like those from champagne, is palatable, is less turbid, and can relatively stably maintain a refreshing flavor over a long period of time, and to provide a method for producing the same.

The present invention is accomplished based on such findings, and the gist of the present invention comprises the following.

(1) In-vessel fermentation type sparkling sake obtained by allowing mixed sake, which is prepared by mixing sake obtained by squeezing with turbid sake obtained by roughly filtering sake mash containing yeast and having fermentation activity, to generate carbon dioxide gas in a hermetically sealed vessel, characterized in that the sparkling sake is prepared by using rice and rice koji as raw materials; carbon dioxide gas present in the vessel is only the carbon dioxide gas substantially generated by secondary fermentation; and the content of the carbon dioxide gas is 3.0 GV or more.
(2) The sparkling sake according to the above (1), wherein the alcohol content of the sparkling sake is in the range of 12 to 16 degrees.
(3) The sparkling sake according to the above (1) or (2), wherein the content of the carbon dioxide gas is in the range of 4.5 to 5.0 GV.
(4) The sparkling sake according to any one of the above (1) to (3), wherein the gas volume reduction rate of the carbon dioxide gas after the lapse of 2 hours in the state where the inside of the vessel is allowed to communicate with the air is 7.0% or less.
(5) The sparkling sake according to any one of the above (1) to (4), wherein the sake meter value of the sparkling sake is in the range of −20 to +15.
(6) A method for producing sparkling sake, characterized by comprising: a mixing step of mixing sake obtained by squeezing with turbid sake obtained by roughly filtering sake mash containing yeast and having fermentation activity so that the mixing ratio may fall within the range of from 1:15 to 19:1; a filling step of filling the mixed sake into a vessel for sale followed by sealing the vessel; a secondary fermentation step of fermenting the mixed sake in the vessel to generate carbon dioxide gas; a swinging step of directing a vessel mouth part in the downward direction while rotating and swinging the bottom of the vessel to accumulate lees deposited inside the vessel into the vessel mouth part; and a lees-removing step of cooling at least the vessel mouth part after depositing the lees into the vessel mouth part to thereby reduce the internal pressure of the vessel to weaken the jet of carbon dioxide gas in the vessel and then opening the vessel mouth part in the state where it is directed in the downward direction to jet the lees accumulated in the vessel mouth part, followed by raising the vessel to the state where the vessel mouth part is directed in the upward direction.
(7) The method for producing the sparkling sake according to the above (6), further comprising, after the lees-removing step, a replenishing step for replenishing the sparkling sake in the vessel whose amount is reduced by the lees-removing step to a standard amount for sale.
(8) The method for producing the sparkling sake according to the above (6) or (7), further comprising, after the lees-removing step, a heating step for killing the yeast and other bacteria and a cooling step.
(9) The method for producing the sparkling sake according to the above (6), (7), or (8), wherein the swinging step is started 6 to 8 days before the lees-removing step, and the gas volume in the vessel during the lees-removing step is 4.43 GV or more.
(10) The method for producing the sparkling sake according to any one of the above (6) to (9), wherein the turbid sake is obtained by roughly filtering the sake mash when the alcohol concentration of the sake mash is in the range of from 10 to 15 degrees which is an index in which the number of yeast in the sake mash increases to the maximum and the activity of the yeast is enhanced.
(11) The method for producing the sparkling sake according to any one of the above (6) to (10), wherein, in the mixing step, the sake has a sake meter value of from −20 to −3; the turbid sake has a sake meter value of from −35 to −10; and both of the sake and the turbid sake have an acidity of 3 or less.
(12) The method for producing the sparkling sake according to any one of the above (8) to (11), wherein warm water is showered in the heating step so that the temperature of the content in the vessel rises to 60° C. to 70° C. within a range of 30 to 40 minutes.
(13) The method for producing the sparkling sake according to any one of the above (8) to (12), wherein, in the cooling step, cold water of 0 to 10° C. is showered over 10 to 20 minutes to cool the content in the vessel for sale.

The present invention has made it possible to provide sparkling sake which generates fine bubbles like those from champagne, is palatable, is less turbid, and can relatively stably maintain a refreshing flavor over a long period of time, and to provide a method for producing the same.

### BRIEF DESCRIPTION OF THE DRAWINGS

FIG. 1 is a flow chart in accordance with the present invention;

FIG. 2 is a drawing showing the state in the vessel after secondary fermentation;

FIG. 3 is a drawing illustrating a swinging step;

FIG. 4 is a drawing illustrating a swinging step;

FIG. 5 is a drawing illustrating neck freezing;

FIG. 6 is a graph showing the temperature conditions of heating; and

FIG. 7 is a photograph showing the state of bubbles in the sparkling sake of the present invention.

### BEST MODE FOR CARRYING OUT THE INVENTION

Hereinafter, the details and the reasons for limitation of the sparkling sake in accordance with the present invention will be described.

The sparkling sake of the present invention is in-vessel fermentation type sparkling sake obtained by allowing mixed sake, which is prepared by mixing sake obtained by squeezing with turbid sake obtained by roughly filtering sake mash containing yeast and having fermentation activity, to generate carbon dioxide gas in a hermetically sealed vessel.

Here, the sake refers to clear pure sake with high transparency which is obtained by separating sake mash from solids such as polished rice and rice koji by squeezing. A detailed production method of the sake will be described below. On the other hand, the turbid sake refers to sake with turbidity obtained by roughly filtering the sake mash. A detailed production method of the sake mash will also be described below. Further, the sake preferably has a sake meter value in the range of from −20 to −3, and the turbid sake preferably has a sake meter value in the range of from −35 to −10. The above ranges allow us to obtain sparkling sake with sharp flavor which is suitable for the sparkling sake of the present invention. Note that the sake meter value is an index showing the specific gravity of sake, which is obtained by keeping the target sake at 15° C., floating a specified hydrometer in the sake, and measuring the specific gravity. The sake having the same specific gravity as the distilled water at 4° C. has a sake meter value of 0. The sake having a lower or higher specific gravity than that takes a plus value or minus value, respectively.

Further, the mixed sake of the sake and the turbid sake is sake obtained by mixing the sake with the turbid sake at a specific proportion as the name suggests, and the detailed production method will be described below. The mixing ratio of the sake to the turbid sake is preferably in the range of from 1:15 to 19:1 depending on the sake meter value, the content of carbon dioxide gas, and the degree of clearness required for the product. When the mixing ratio is smaller than 1:15 (the proportion of the sake is smaller), the amount of the turbid sake is too large. As a result, the amount of lees also tends to be increased to complicate the lees-removing step to be described below. On the other hand, when the mixing ratio is larger than 19:1 (the proportion of the sake is larger), sufficient carbon dioxide gas cannot be obtained because the amount of the turbid sake is too small. The mixing ratio of the sake to the turbid sake is more preferably in the range of from 4:1 to 19:1 in view of obtaining clear sake.

The sparkling sake of the present invention is characterized in that it is prepared by using rice and rice koji as raw materials; carbon dioxide gas present in the vessel is only the carbon dioxide gas substantially generated by secondary fermentation; and the content of the carbon dioxide gas is 3.0 GV or more. The carbon dioxide gas composed only of the carbon dioxide gas generated in secondary fermentation allows us to obtain sparkling sake which generates finer bubbles than those obtained by conventional techniques in which carbon dioxide gas is blown using a carbonator or the like, and which is palatable when drinking the same. Further, a refreshing flavor peculiar to sparkling sake can be realized by setting the content of the carbon dioxide gas to 3.0 GV or more, wherein 3.0 GV corresponds to a high content of carbon dioxide gas in the conventional sparkling sake.

Here, “GV (gas volume)” is one of the indices of carbon dioxide gas (CO₂) contained, and it represents a value obtained by dividing the volume of carbon dioxide gas under conditions of 1 atmosphere and 15.6° C. by the volume of the target liquid (sake in the present invention) after carbon dioxide gas is completely removed from the target liquid. Although the content of carbon dioxide gas can also be represented by “g/l” or “%”, GV is effective as an index independent of temperature, and it is the unit generally used in the beverage industry.

The alcohol content of the sparkling sake is preferably in the range of from 12 to 16 degrees. When the alcohol content is less than 12 degrees, the content of alcohol is too low to sufficiently bring out the merits of sake. In addition, in the conventional production methods, it is required to set the alcohol content at a low value (less than 12 degrees) so that yeast may not be killed. However, as described below, the present invention can maintain a high carbon dioxide gas content while increasing the alcohol content by setting the mixing ratio of turbid sake at a higher level than before and by performing a predetermined lees-removing step. As a result, the effect of the present invention (palatable and refreshing flavor) is significantly exhibited. On the other hand, when the alcohol content exceeds 16 degrees, yeast will be killed because the content of alcohol is too high. As a result, it may be impossible to obtain sufficient amount of carbon dioxide gas.

The content of carbon dioxide gas in the sparkling sake according to the present invention is 3.0 GV or more as described above, but it is more preferably in the range of from 4.5 to 5.0 GV because this range enables generation of fine bubbles, improvement in the taste when drinking sparkling sake, and realization of a refreshing flavor peculiar to sparkling sake. On the other hand, when the content of carbon dioxide gas is less than 4.5 GV, the amount of carbon dioxide gas is too small to sufficiently exhibit a refreshing flavor given by the carbon dioxide gas. When the content of carbon dioxide gas exceeds 5.0 GV, the amount of carbon dioxide gas is too large to enjoy flavor peculiar to sake.

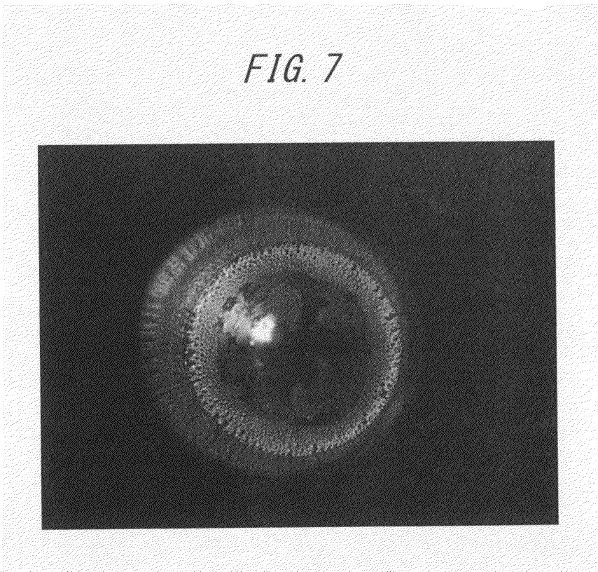

The sparkling sake of the present invention has a feature of generating fine bubbles like those generated from champagne, and since the size of these bubbles is generally smaller than that of the bubbles from the conventional carbonated beverage obtained by blowing carbon dioxide gas by means of a carbonator or the like, the sparkling sake of the present invention is palatable and gives a fine taste. Here, FIG. 7 is a photograph showing the state of the sparkling sake of the present invention which is filled into a glass and observed from the upper part of the glass. This figure shows that fine bubbles are generated, particularly that bubbles peculiar to champagne rising from the central part of the glass (bubbles rising apart from the inner wall of the glass) are similarly generated in the case of the sparkling sake of the present invention.

The sparkling sake of the present invention also has a feature of retaining carbon dioxide gas therein for a longer period of time than a common carbonated beverage, and specifically, the gas volume reduction rate of the carbon dioxide gas after the lapse of 2 hours in the state where the inside of the vessel is allowed to communicate with the air is preferably 7.0% or less. If the gas volume reduction rate can be suppressed to 7.0% or less, the refreshing flavor of carbon dioxide gas can be enjoyed for a long period of time like champagne. On the other hand, when it exceeds 7.0%, there will be an adverse effect that the carbon dioxide gas is quickly discharged. Here, the gas volume reduction rate in the case of the present invention refers to the proportion (%) of the gas volume of the carbon dioxide gas which has been reduced after the lapse of a predetermined time in the state where the sparkling sake is allowed to communicate with the air to the gas volume of the carbon dioxide gas before being allowed to communicate with the air. With respect to the conditions for allowing the carbon dioxide gas to communicate with the air, 720 ml of the sparkling sake of the present invention is put into a vessel whose mouth part has a diameter of 1.5 cm (a common champagne bottle of 750 ml), and the lid is opened to allow the sparkling sake to communicate with the air.

It is one of the features that the sparkling sake of the present invention is highly transparent and clear compared with the conventional sparkling sake.

Further, the sake meter value of the sparkling sake is preferably in the range of −20 to +15. When this value is less than −20, the sparkling sake will tend to be sweet and the refreshing flavor according to the present invention may not sufficiently be realized. On the other hand, when it is more than +15, the resulting sparkling sake will have poor taste, in which an original flavor of sake is lost.

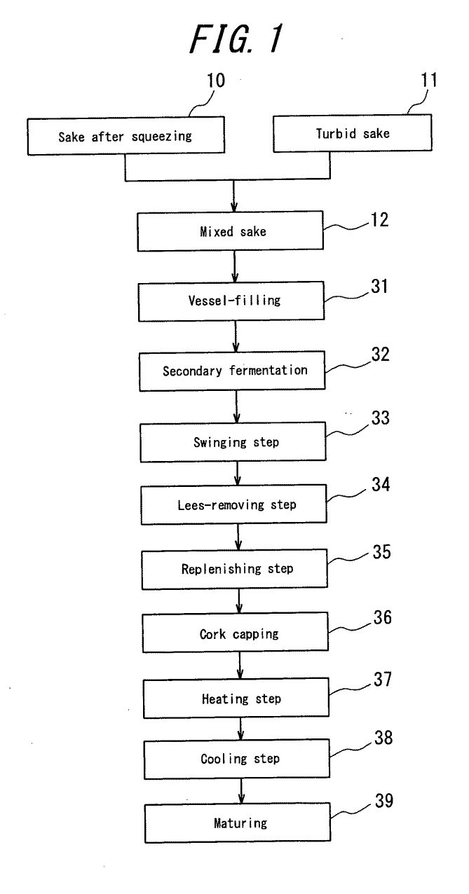

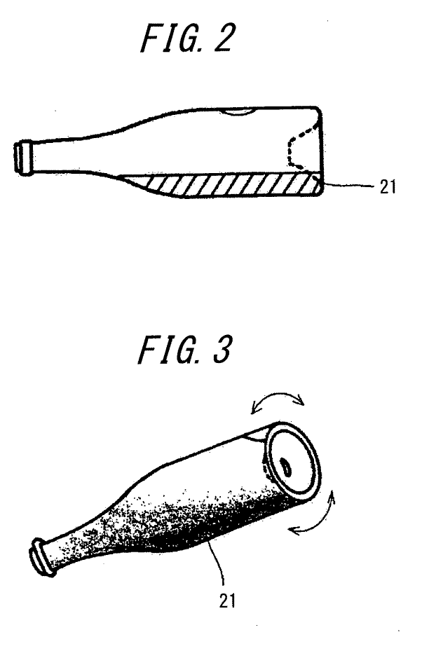

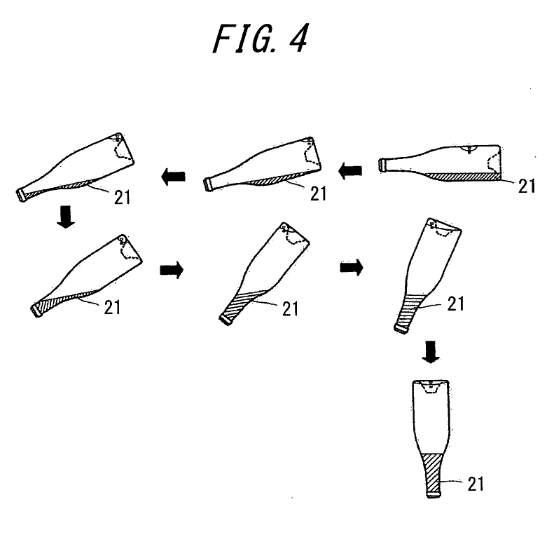

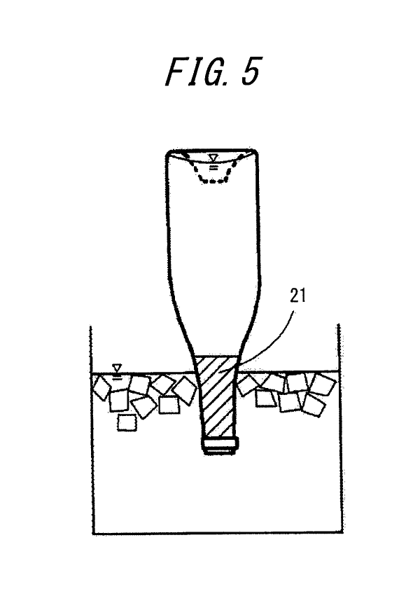

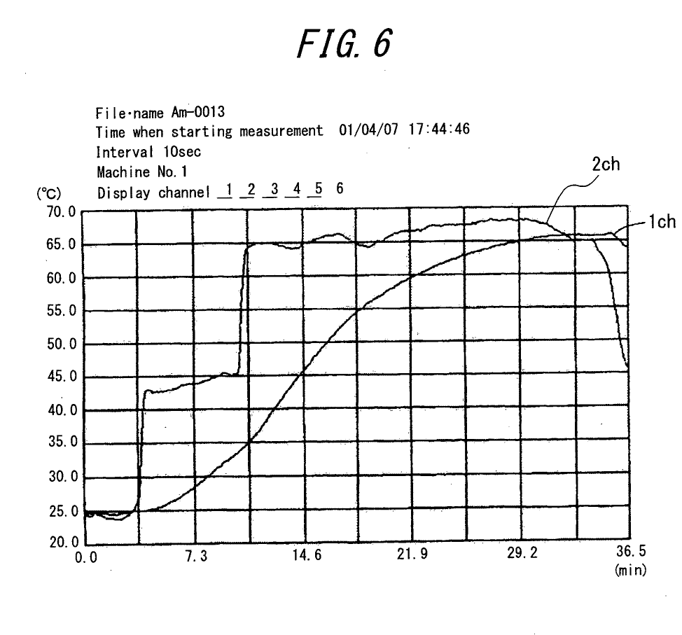

Next, a method for producing the sparkling sake according to the present invention will be described with reference to drawings. FIG. 1 is a flow chart in accordance with the present invention. FIG. 2 is a drawing showing the inside of the vessel at the time of completing secondary fermentation. FIG. 3 is a drawing illustrating a swinging step. FIG. 4 is a drawing illustrating a swinging step. FIG. 5 is a drawing illustrating the state where the mouth part before the lees-removing step is cooled. FIG. 6 is a graph showing the temperature change during heating.

The production method according to the present invention is characterized by comprising: a mixing step of mixing sake obtained by squeezing with turbid sake obtained by roughly filtering sake mash containing yeast and having fermentation activity so that the mixing ratio may fall within the range of from 1:15 to 19:1; a filling step of filling the mixed sake into a vessel for sale followed by sealing the vessel; a secondary fermentation step of fermenting the mixed sake in the vessel to generate carbon dioxide gas; a swinging step of directing a vessel mouth part in the downward direction while rotating and swinging the bottom of the vessel to accumulate lees deposited inside the vessel into the vessel mouth part; and a lees-removing step of cooling the vessel mouth part after depositing the lees into the vessel mouth part to thereby reduce the internal pressure of the vessel to weaken the jet of carbon dioxide gas in the vessel and then opening the vessel mouth part in the state where it is directed in the downward direction to jet the lees accumulated in the vessel mouth part, followed by raising the vessel to the state where the vessel mouth part is directed in the upward direction. Thus, it is possible to remove the lees accumulated in the inside of a vessel for sale and can obtain sparkling sake which generates fine bubbles like those from champagne, is palatable, is less turbid, and has a refreshing flavor even by a production method for obtaining sparkling sake by performing secondary fermentation within the vessel.

A method for producing sake 10 to be used as a raw material is as follows. Unpolished rice is polished to obtain polished rice, which is then cleaned. Then, the cleaned rice is immersed in water followed by steaming. Aspergillus is spread over the steamed rice to prepare koji. Koji, steamed rice, and yeast are added to water to prepare primary sake mash. After completion of primary fermentation, the sake mash is in the state of a liquid. This sake mash is subjected to squeezing to separate it into clean sake 10 and sake lees (portion containing koji, yeast, and the like). In the present invention, this sake portion 10 is used first. The sake meter value of the sake in this period is approximately from −20 to −3, preferably approximately from −15 to −5, because such a sake meter value allows us to obtain sparkling sake which is transparent and palatable, and also allows us to obtain mixed sake which contains only a small amount of lees and has a high yeast activity which allows secondary fermentation to proceed to a predetermined gas pressure by setting the mixing ratio of sake and turbid sake to the above ratio.

Next, sake mash is produced in the same way as described above in another vessel. With respect to this sake mash, it is preferred to use the sake mash before completing primary fermentation since the sake mash in the period where it has high fermentation activity by increasing the number of yeast to the maximum is preferred. In the present invention, the number of yeast increases to the maximum when the highest temperature is reached, wherein the number of yeast present is about 200 million/cm³. This timing is estimated by the alcohol concentration of sake mash which is 10 to 12%. As an inventor's experience value, the number of yeast will reach the maximum value around the 10th day after starting primary fermentation. It is possible to obtain mixed sake containing only a small amount of lees and having a strong secondary fermentation activity by mixing sake with turbid sake in which the number of yeast of the sake mash has increased to the maximum and the activity of yeast is high.

This sake mash is roughly filtered to obtain turbid sake 11 having high fermentation activity. The rough filtering is performed by using, for example, an artificial fiber made from 0.5 mm polypropylene, but any other method may be used.

The turbid sake 11 having high fermentation activity is mixed with the sake 10 obtained by squeezing to obtain mixed sake 12, wherein about 1 to 19 parts of the sake is mixed with about 15 to 1 part of the turbid sake. When secondary fermentation is performed by using only the turbid sake 11, the amount of lees will be increased and much sake will be lost in the lees-removing step. Therefore, the above ratio is the most preferred mixing ratio.

The alcohol content of the mixed sake 12 is adjusted to meet the standard for commercial sake, specifically adjusted to about 12.0 to 16.0%. When the alcohol content is too high (16% or more), the alcohol itself will act as an inhibition factor in post-fermentation. Therefore, it is preferred to perform preparation so that the alcohol content may be 16 degrees or less. Further, since remaining non-fermentable oligosaccharide turns into assimilable sugar which is saccharified by saccharogenic amylase, the initial sugar concentration for post-fermentation is enough and sugar supplement is not required. This method is significantly different from the method for producing champagne in that a solution of cane sugar and yeast is added in the secondary fermentation of champagne.

The mixed sake 12 in which the alcohol content is adjusted is filled into a vessel for sale (for example, a pressure bottle like a champagne bottle) while being agitated so that the quality in all vessels may be uniform. Preferably, a 750 ml champagne bottle is used. In a vessel-filling step 31, it is preferred to quickly complete the mixing and filling within 3 hours after roughly filtering of the sake mash.

After the filling, the bottle is capped with a crown cap, a screw cap or the like for sealing.

The vessel for sale in which the mixed sake 12 is filled and sealed is maintained at a predetermined temperature for a predetermined period of time for secondary fermentation 32. In the meantime, carbon dioxide gas concentration increases with time. The vessel is preferably stored horizontally at a temperature of from 5 to 10° C. for 3 months or more. Yeast is activated in the vessel in the meantime, and carbon dioxide gas is generated in the vessel for sale caused by secondary fermentation. When the gas volume is increased to 4.43 GV or more, the temperature is reduced so that secondary fermentation may stop, because if the fermentation is stopped while the gas pressure is low, the effect of sparkling properties may be small. Thus, sparkling sake 13 is produced.

At the time when the secondary fermentation stops, lees 21 are in the state where it adheres to the inside of the vessel as shown in FIG. 2. Then, in order to remove these lees, a swinging step 33 is performed first. This swinging step is similar to remuage which is well known in the method for producing champagne. However, the biggest difference with the remuage of champagne is the quality of lees. The lees of champagne is viscous while the lees of sake is free flowing. Therefore, the lees of sake has a feature of being liable to float in sake. Also in the present invention, the swinging step is performed while observing the falling state of the lees. It is possible to gradually allow the lees in the vessel to fall toward the vessel mouth part by starting the swinging step from 6 to 8 days before starting a lees-removing operation.

Specifically, as shown in FIG. 3, the bottom of the vessel is swung while being rotated or swung in all directions so that the lees adhering to the inside of the vessel may be peeled off and allowed to fall toward the vessel mouth part. The swinging step is started about 6 to 8 days, more preferably about 7 to 8 days before starting the lees-removing step, wherein the vessel mouth part is gradually directed in the downward direction as shown in FIG. 4 to allow the lees to gradually fall so that the lees are accumulated in the vessel mouth part on the day when the lees-removing step is started. Note that it is preferred that this swinging step be performed at a temperature of from 0 to 3° C., preferably from 0 to 2° C.

In the swinging step, it is also possible to use a machine such as a gyropalette used for the method for producing champagne.

Afterward, the vessel is taken out of a cooling box to perform the lees-removing step 34. The lees-removing step is a step to which degorgement by neck freezing in the method for producing champagne has been applied. For example, as shown in FIG. 5, the vessel is put in ice water kept at a temperature of from 0 to 4° C. with the vessel mouth part facing downwardly to cool at least the vessel mouth part, preferably the whole vessel to reduce the internal pressure to weaken the jet of carbon dioxide gas, so that the cooling of at least the lees part allows the air in the vessel to shrink, reduces the action of yeast, and enables prompt discharge of only the lees at the time of opening. In addition, it is also possible to use machinery used in the method for producing champagne such as a rotating type neck freezer.

It is preferred to start the swinging step from 6 to 8 days before starting the lees-removing step, and the gas volume in the vessel at the time of starting the lees-removing step is preferably 4.43 GV or more. The lees in the vessel can be gradually lowered to the vessel mouth part by starting the swinging step from 6 to 8 days before the lees-removing operation. By setting the gas volume at 4.43 GV or more (for example, the internal pressure of the vessel is 2 to 5 kg/cm² at a temperature of 0 to 3° C.), the internal pressure is increased to a sufficiently high level to allow the pressure in the vessel to jet the lees outside of the vessel at the time of opening. After jetting the lees, the vessel is raised to the state where the vessel mouth part is directed in the upward direction.

The volume of the sparkling sake in the vessel is reduced by the amount corresponding to the lees removed at the opening. Therefore, the clean sparkling sake from which the lees are already removed and has the same quality is replenished (replenishing step 35) to meet the standard volume for sale. This is a step to which dosage of the method for producing champagne is applied, wherein even when the volume of the sparkling sake in the vessel is reduced during the lees-removing step, a predetermined volume can be secured by adding the amount corresponding to the reduced amount to the vessel for sale. In the Liquor Tax Law, it is forbidden to mix yeast or sake mash in the middle of fermentation with sake. This problem of the Liquor Tax Law can be solved by mixing sparkling sake when replenishment is required.

In the method for producing champagne, it is possible to use the semiautomatic operation by a TDD machine, wherein degorgement, wine suction, sugar replenishment, and wine supply are performed. It is also possible to apply this machine to the present invention to perform the lees-removing step and the replenishing step by means of the machine.

In the method for producing champagne, champagne is then stored and enters a maturing stage. On the other hand, sake is heated to heat-sterilize the same and to completely stop secondary fermentation thereof. There is a big difference at this point.

The sparkling sake 13 after the replenishing step is subjected to cork capping 36, wherein the vessel is capped with a corker which has been used for sparkling liquor such as champagne and fixed with a wire for exclusive use so that the cork can resist internal pressure.

The production method of the present invention preferably comprises a heating step for killing the yeast and other bacteria and a cooling step after the lees-removing step. The heating step after the lees-removing step has an effect to kill the yeast to thereby stop secondary fermentation and prevent the quality from changing in the market. Further, the heating is performed after the sparkling sake is filled in the vessel so that it may not impair flavor.

In the present invention, the heating step 37 is performed under the temperature conditions as shown in FIG. 6, wherein 1ch represents the temperature of the sparkling sake 13 in the vessel, and 2ch represents the temperature conditions of the warm water showered to the vessel. As is apparent from this figure, the sparkling sake 13 is warmed from 24.7° C. to 65° C. in 29.2 minutes, is maintained at 65° C. for about 6 minutes, and is then cooled.

Specifically, as shown in the graph of 2ch, the warm water is showered at three-stage temperatures, wherein the temperature is increased to 45° C. and maintained for 6 or 7 minutes at this temperature, is then increased to 65° C. and maintained for about 20 minutes, and is decreased again to 45° C. By showering the warm water of these temperatures, the temperature of the sparkling sake in the vessel gradually increases to 65° C. in 29.2 minutes and is maintained at 65° C. for about 6 minutes.

The purpose of the showering of warm water is to efficiently increase the temperature of the sparkling sake in the vessel up to the target temperature, thereby capable of preventing rapid temperature increase to keep the quality at a specified level.

The cooling step 38 is performed after the heating step. In the cooling step, cold water of 0 to 15° C., preferably 0 to 5° C., is showered to the vessel for 15 minutes. The purpose of the showering of cold water is to efficiently decrease the temperature of the sparkling sake in a short time so as to keep the quality at a specified level.

The sparkling sake 13 after the heating step and the cooling step is subjected to maturing 39 in a low darkroom such as a cellar at 10 to 20° C., preferably at 15° C., for six months or more. Thereby, the taste is stabilized and a mellow taste can be attained.

Those described above only show an example of the embodiments of the present invention, and various changes can be made to them within the claims.

Examples of the present invention will be described below.

### Example 1

In Example 1, as shown in FIG. 1, the sparkling sake 13 as a sample was obtained by performing the following steps, in turn: the mixing step of mixing the sake 10 (sake meter value: −20 to −3) obtained by squeezing with the turbid sake 11 obtained by roughly filtering the sake mash (sake meter value: −35 to −10) containing yeast and having fermentation activity so that the mixing ratio may fall within the range of from 1:15 to 19:1; the filling step 31 of filling the resulting mixed sake 12 into a vessel for sale followed by sealing the vessel; the secondary fermentation step 32 of fermenting the mixed sake in the vessel to generate carbon dioxide gas; the swinging step 33 of directing the vessel mouth part in the downward direction while rotating and swinging the bottom of the vessel to accumulate the lees 21 deposited inside the vessel into the vessel mouth part; and the lees-removing step 34 of cooling the vessel mouth part after depositing the lees 21 into the vessel mouth part to thereby reduce the internal pressure of the vessel to weaken the jet of carbon dioxide gas in the vessel and then opening the vessel mouth part in the state where it is directed in the downward direction to jet the lees accumulated in the vessel mouth part, followed by raising the vessel to the state where the vessel mouth part is directed in the upward direction; the replenishing step 35 of replenishing the sparkling sake 13 in the vessel whose amount is reduced during the lees-removing step 34 to the standard amount for sale, followed by the capping 36; the heating step 37 for killing the yeast and other bacteria and the cooling step 38, under the temperature conditions as shown in FIG. 6; and the maturing step 39 for maturing the sparkling sake in a low darkroom at 5° C. for six months or more.

Table 1 shows the sake meter value, the alcohol content (degree), the acidity, the amino acid degree, and the carbon dioxide gas volume (GV) of the resulting sample.

### Example 2

In Example 2, a sample of the sparkling sake having a gas volume value of carbon dioxide gas as shown in Table 1 (3.171 GV) was obtained by opening the vessel of the sample in Example 1 and then moving the sparkling sake in the vessel to another vessel.

### Comparative Example 1

In Comparative Example 1, a sample of the sparkling sake was obtained by blowing carbon dioxide gas using a carbonator to increase the value of the carbon dioxide gas volume (numerical values are shown in Table 1) of dry junmai-shu (“Tanigawadake super dry junmai-shu” manufactured by Nagaishuzo Corp.) which has the sake meter value, the alcohol content (degree), the acidity, and the amino acid degree as shown in Table 1.

TABLE 1

| | Sake | Alcohol | | Amino | Gas |
|---|---|---|---|---|---|
| | meter | content | | acid | volume |
| | value | (%) | Acidity | degree | (GV) |
| Example 1 | 10 | 13.3 | 1.6 | 1.4 | 6.062 |
| Example 2 | 10 | 13.3 | 1.6 | 1.4 | 3.171 |
| Comparative | 10 | 13.5 | 1.2 | 1.3 | 3.562 |
| Example 1 | | | | | |

(Evaluation)

The samples obtained as described above were subjected to various tests. The methods for evaluating the tests performed in the present Examples are shown below.

(1) Durability of Carbon Dioxide Gas

Each sample from Examples and Comparative Example was allowed to stand in ice water until the temperature was stabilized (3.0 to 7.0° C.); the bottle containing each sample was then shaken vigorously; and each sample was then allowed to stand for 10 minutes in ice water again to measure the gas volume (GV). Subsequently, the vessel was returned in ice water and allowed to stand for 2 hours in the state where it is unstopped, and then the vessel was taken out of the ice water and the gas volume (GV) of the sample was measured again according to substantially the same procedure as described above.

The resulting gas volume reduction rate (GV reduction rate) (%) was evaluated in accordance with the following criteria, and the results are shown in Table 2.

◯: in case that a GV reduction rate is 7% or less

x: in case that a GV reduction rate exceeds 7%

TABLE 2

| | Carbon dioxide gas volume | | | |
|---|---|---|---|---|
| | Before | After | | |
| | leaving to | leaving to | GV reduction | |
| | stand (GV) | stand (GV) | rate (%) | Evaluation |
| Example 1 | 6.062 | 5.929 | 2.2 | ∘ |
| Example 2 | 3.171 | 3.091 | 6.7 | ∘ |
| Comparative | 3.562 | 3.185 | 10.6 | x |
| Example 1 | | | | |

(2) Taste

A sample from Example 1 and samples A to F for evaluation (all are sparkling sake) were each poured into substantially the same flute glass for champagne and drunk by 6 men and women in twenties to fifties at a temperature of from 5 to 8° C. without disclosing the information of each sample to them. Their comments on these samples and each evaluator's most favorite sake were investigated to thereby evaluate the taste. Results of the investigation are shown in Table 3.

Note that samples A to F for evaluation are commercial sparkling sake and have the following features:

Sample A: in-vessel fermentation type sake, alcohol content: 17 degrees, sake meter value: +3 to +5, turbid, gas volume: unknown;

Sample B: in-vessel fermentation type sake, sake meter value: +5, turbid, gas volume: unknown;

Sample C: in-vessel fermentation type sake, alcohol content: 12 to 13 degrees, sake meter value: −0.5, turbid, gas volume: unknown;

Sample D: in-vessel fermentation and gas-blowing combined-type sake, alcohol content: 9 degrees, sake meter value: −9 to −12, not turbid, gas volume: 2.84 GV;

Sample E: gas-blowing type sake, alcohol content: 10.3 degrees, not turbid, gas volume: 2.85 GV; and

Sample F: gas-blowing type sake, alcohol content: 11 to 12 degrees, sake meter value: −26, not turbid, gas volume: 4.9 GV.

TABLE 3

| | Woman in her | Woman in her | Woman in her | Man in his | Man in his | Man in his |
|---|---|---|---|---|---|---|
| | twenties | thirties | forties | thirties | forties | fifties |
| Sample of | felt strong | good aroma, | soft taste, gas is fine | sharp, gas is fine, | aroma like champagne, | very easy to drink, tasty, |
| Example 1 | flavor, | flavor is | | sharpness | thin taste, best gas | satisfactorily sharp, base of |
| | refreshing | refreshing | | | feeling | sake is maintained |
| Sample A | like juice of | both aroma | disagreeable due to acid | sweet aroma, heavy | taste like grated | heavy aroma, yeasty flavor, |
| | grated radish | and flavor | taste | taste, dry, gas is | radish, heavy taste | has sake taste, image of sake |
| | | not quite | | weak than expected | | mash containing CO₂ |
| | | satisfactory | | | | |
| Sample B | Bitter | hot flavor, | foaming feeling, but a | light, active feeling, | heavy, not sharp, gas | has aroma, hidden aroma, |
| | | but good | little acid taste and | gas is sensed | is second best | light aroma, light-bodied, |
| | | aroma | later bitterness | | | refreshing |
| Sample C | no foaming | feel remaining | can drink easily, not | hardly feel gas, thin | little aroma, acid | gentle aroma, acid, light- |
| | feeling | in throat after | like sparkling sake | | taste | bodied, good feeling through |
| | | drinking, has a | | | | throat, thin |
| | | little peculiar | | | | |
| | | aroma | | | | |
| Sample D | easy to | good aroma, | interested appearance and | feel sweet taste, | little aroma, light, | feel full of CO₂ in mouth, |
| | drink | easy to drink | taste like soda pops, not | coarse gas | unsatisfactory, apple- | taste has width, gentle |
| | | | feel like sake if cold | | like | |
| Sample E | sour?, | poorer aroma | no foaming feeling, not | almost no gas, old | old aroma, almost no | aroma of sake containing |
| | tingling | and flavor than | different from ordinary | aroma | gas, ordinary old sake | CO₂ |
| | | other sake | sake, because D was | | | |
| | | | drunk previously? | | | |
| Sample F | poor aroma | not delicious | feel weak gas | peculiar aroma, | poor balance | acid taste is conspicuous, |
| | | | | another drink is not | | has peculiar aroma |
| | | | | needed | | |
| Favorite | Example 1 | Example 1 | Example 1 | Example 1 | Example 1 | Example 1 |
| taste | | | | | | |

From the results in Table 2, it was found that the samples of Examples 1 and 2 had a smaller GV reduction rate (%) and a better lastingness of carbon dioxide gas than the sample of Comparative Example 1. Further, it was found that bubbles of carbon dioxide gas generated from the samples of Examples 1 and 2 were felt smaller and more palatable than those from the sample of Comparative Example 1.

Furthermore, from the results in Table 3, it was found that the sample of Example 1 was highly evaluated in terms of the strength of carbon dioxide gas, the fineness of bubbles, and the goodness of flavor compared with other sparkling sake, and that it had a taste meeting the general consumer's demand.

The present invention has made it possible to provide sparkling sake which generates fine bubbles like those from champagne, is palatable, is less turbid, and has a refreshing flavor, and to provide a method for producing the same.

1. An in-vessel fermentation type sparkling sake obtained by allowing mixed sake, which is prepared by mixing sake obtained by squeezing with turbid sake obtained by roughly filtering sake mash containing yeast and having fermentation activity, to generate carbon dioxide gas in a hermetically sealed vessel, characterized in that
the sparkling sake is prepared by using rice and rice koji as raw materials; carbon dioxide gas present in the vessel is the carbon dioxide gas substantially generated by secondary fermentation; and the content of the carbon dioxide gas is 3.0 GV or more.

2. The sparkling sake according to claim 1, wherein the alcohol content of the sparkling sake is in the range of 12 to 16 degrees.

3. The sparkling sake according to claim 1 or 2, wherein the content of the carbon dioxide gas is in the range of 4.5 to 5.0 GV.

4. The sparkling sake according to claim 1, 2, or 3, wherein the gas volume reduction rate of the carbon dioxide gas after the lapse of 2 hours in the state where the inside of the vessel is allowed to communicate with the air is 7.0% or less.

5. The sparkling sake according to any one of claims 1 to 4, wherein the sake meter value of the sparkling sake is in the range of −20 to +15.

6. A method for producing sparkling sake, characterized by comprising:
a mixing step of mixing sake obtained by squeezing with turbid sake obtained by roughly filtering sake mash containing yeast and having fermentation activity so that the mixing ratio may fall within the range of from 1:15 to 19:1;
a filling step of filling the mixed sake into a vessel for sale followed by sealing the vessel;
a secondary fermentation step of fermenting the mixed sake in the vessel to generate carbon dioxide gas;
a swinging step of directing a vessel mouth part in the downward direction while rotating and swinging the bottom of the vessel to accumulate lees deposited inside the vessel into the vessel mouth part; and
a lees-removing step of cooling at least the vessel mouth part after depositing the lees into the vessel mouth part to thereby reduce the internal pressure of the vessel to weaken the jet of carbon dioxide gas in the vessel and then opening the vessel mouth part in the state where it is directed in the downward direction to jet the lees accumulated in the vessel mouth part, followed by raising the vessel to the state where the vessel mouth part is directed in the upward direction.

7. The method for producing the sparkling sake according to claim 6, further comprising, after the lees-removing step, a replenishing step for replenishing the sparkling sake in the vessel whose amount is reduced by the lees-removing step to a standard amount for sale.

8. The method for producing the sparkling sake according to claim 6 or 7, further comprising, after the lees-removing step, a heating step for killing the yeast and other bacteria and a cooling step.

9. The method for producing the sparkling sake according to claim 6, 7, or 8, wherein the swinging step is started 6 to 8 days before the lees-removing step, and the gas volume in the vessel during the lees-removing step is 4.43 GV or more.

10. The method for producing the sparkling sake according to any one of claims 6 to 9, wherein the turbid sake is obtained by roughly filtering the sake mash when the alcohol concentration of the sake mash is in the range of from 10 to 15 degrees which is an index in which the number of yeast in the sake mash increases to the maximum and the activity of the yeast is enhanced.

11. The method for producing the sparkling sake according to any one of claims 6 to 10, wherein, in the mixing step, the sake has a sake meter value of from −20 to −3; the turbid sake has a sake meter value of from −35 to −10; and both of the sake and the turbid sake have an acidity of 3 or less.

12. The method for producing the sparkling sake according to any one of claims 8 to 11, wherein warm water is showered in the heating step so that the temperature of the content in the vessel rises to 60° C. to 70° C. within a range of 30 to 40 minutes.

13. The method for producing the sparkling sake according to any one of claims 8 to 12, wherein, in the cooling step, cold water of 0 to 10° C. is showered over 10 to 20 minutes to cool the content in the vessel for sale.
